(19) United States
(12) Patent Application Publication
(10) Pub. No.: US 2005/0006814 A1
(43) Pub. Date: Jan. 13, 2005

(54) Injection molding method

(76) Inventor: Da-Yu Lin, Taipei (TW)

Correspondence Address: BIRCH STEWART KOLASCH & BIRCH, PO BOX 747, FALLS CHURCH, VA, 22040-0747, US

(21) Appl. No.: 10/612,964

(22) Filed: Jul. 7, 2003

(51) Int. Cl. B29C 45/14

(52) U.S. Cl. 264/255; 264/328.8

(57) ABSTRACT

An injection molding method for a mold having a first cavity and a second cavity. The injection molding method includes the steps of: (a) hardening a plastic film; (b) placing the plastic film in the first cavity; (c) injecting a molten first plastic material into the first cavity to attach the plastic film onto the surface of the first plastic material, such that the plastic film and the first plastic material combine to form a first object; (d) separating the first object from the first cavity; (e) placing the first object in the second cavity; (f) injecting a molten second plastic material into the second cavity to combine the first object with the second plastic material to form a second object; and (g) separating the second object from the second cavity.

### BACKGROUND OF THE INVENTION

1. Field of the Invention

The present invention relates to an injection molding method, and in particular to a dual injection molding method.

2. Description of the Related Art

Electronic devices generally have a plastic housing to meet the demand for light weight. Nevertheless, because plastic housings are easily damaged, an additional hardening process is performed to protect the surfaces thereof, particularly for the surfaces of transparent plastic housings. The conventional hardening process employs a chemical soaking method to harden the plastic housings.

Moreover, in order to present an aesthetically pleasing appearance, a conventional plastic housing may combine a transparent plastic panel with a colored plastic body. The conventional plastic housing is formed by a conventional dual injection molding method. When the transparent plastic panel is combined with the colored plastic body, the conventional plastic housing cannot be hardened using the chemical soaking method as the colored plastic body can be damaged by a chemical soak medicament. In order to protect the transparent plastic panel from wear, the transparent plastic panel requires polishing. The polishing process however complicates the manufacture of the conventional plastic housings and the precision thereof is not easily controlled.

Hence, there is a need to provide an injection molding method to overcome the aforementioned problems. Two plastic materials are combined to form a plastic housing by the injection molding method, and the surface of the plastic housing formed by the injection molding method has enhanced durability.

### SUMMARY OF THE INVENTION

Accordingly, an object of the invention is to provide an injection molding method for a mold having a first cavity and a second cavity. The method comprises the steps of: (a) hardening a plastic film; (b) placing the plastic film in the first cavity; (c) injecting a molten first plastic material into the first cavity to attach the plastic film onto the surface of the first plastic material, such that the plastic film and the first plastic material combine to form a first object; (d) separating the first object from the first cavity; (e) placing the first object in the second cavity; (f) injecting a molten second plastic material into the second cavity to combine the first object with the second plastic material to form a second object; and (g) separating the second object from the second cavity.

Preferably, the plastic film and the first plastic material are composed of a same plastic material.

Preferably, the plastic film and the first plastic material are transparent.

Preferably, the second plastic material is colored.

Preferably, in the step (a), the plastic film is hardened by a chemical soaking method.

Preferably, the injection molding method further comprises a step between the steps (d) and (e) of turning the mold to locate the second cavity in a position corresponding to the first object.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a plastic housing formed by the injection molding method of the invention; and

FIG. 2 is a cross section taken along line A-A of FIG. 1.

### DETAILED DESCRIPTION OF THE INVENTION

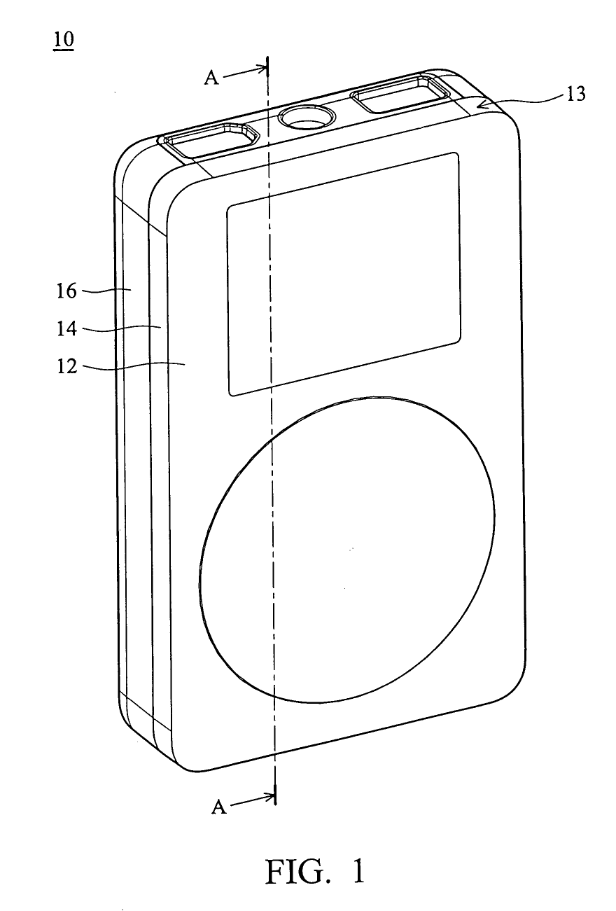

FIG. 1 shows a plastic housing 10 formed by the injection molding method of the invention. The plastic housing 10 includes a transparent plastic film 12, a transparent plastic material 14 and a colored plastic material 16. The present injection molding method is for use with a rotary mold (not shown). The rotary mold has a first cavity (not shown) and a second cavity (not shown).

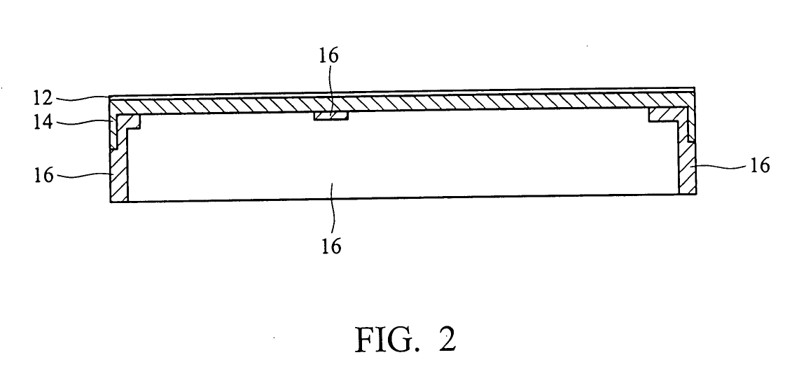

Referring to FIG. 1 and FIG. 2, the transparent plastic film 12, which has a thickness of 0.015 mm, is hardened by means of a chemical soaking method. The hardened transparent plastic film 12 is resistant to wear and high temperature. The hardened transparent plastic film 12 is placed on the inner wall of the first cavity. Then, molten transparent plastic material 14 is injected into the first cavity. Because the hardened transparent plastic film 12 is resistant to high temperature, the hardened transparent plastic film 12 does not melt in the first cavity. The hardened transparent plastic film 12 is attached to the surface of the transparent plastic material 14 and combined with the transparent plastic material 14 to form a first transparent housing portion 13. The first transparent housing portion 13 is then separated from the first cavity and the mold is turned clockwise or counterclockwise to locate the second cavity in a position corresponding to the first transparent housing portion 13. The first transparent housing portion 13 is placed in the second cavity. Molten colored plastic material 16 is then injected into the second cavity and combines with the first transparent housing portion 13 to form the plastic housing 10. Finally, the plastic housing 10 is separated from the second cavity.

Accordingly, the plastic housing 10 formed by the injection molding method of the invention achieves the object of combining a transparent surface with a colored body. In addition, the transparent panel (the first transparent housing portion 13) of the plastic housing 10 is durable and resistant to wear and damage.

Specifically, since the transparent plastic film 12 and the transparent plastic material 14 are bonded together on the condition that they have a same material interface, the transparent plastic film 12 and the transparent plastic material 14 are composed of a same material.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An injection molding method for a mold having a first cavity and a second cavity, comprising the steps of:
(a) hardening a plastic film;
(b) placing the plastic film in the first cavity;
(c) injecting a molten first plastic material into the first cavity to attach the plastic film onto the surface of the first plastic material, such that the plastic film and the first plastic material combine to form a first object;
(d) separating the first object from the first cavity;
(e) placing the first object in the second cavity;
(f) injecting a molten second plastic material into the second cavity to combine the first object with the second plastic material to form a second object; and
(g) separating the second object from the second cavity.

2. The injection molding method as claimed in claim 1, wherein the plastic film and the first plastic material are composed of a same plastic material.

3. The injection molding method as claimed in claim 1, wherein the plastic film and the first plastic material are transparent.

4. The injection molding method as claimed in claim 1, wherein the second plastic material is colored.

5. The injection molding method as claimed in claim 1, wherein the plastic film in the step (a) is hardened by means of a chemical soaking method.

6. The injection molding method as claimed in claim 1, further comprising a step between the steps (d) and (e):
turning the mold to locate the second cavity in a position corresponding to the first object.
